(19) United States
(12) Patent Application Publication
(10) Pub. No.: US 2001/0002656 A1
(43) Pub. Date: Jun. 7, 2001

(54) Process for preparing monodisperse adsorber resins and their use

(76) Inventors: Ulrich Schnegg, Leverkusen (DE); Georg Martin, Langenfeld (DE); Lothar Feistel, Delitzsch (DE); Werner Struver, Leverkusen (DE); Michael Holzbrecher, Engelskirchen (DE)

Correspondence Address: BAYER CORPORATION, PATENT DEPARTMENT, 100 BAYER ROAD, PITTSBURGH, PA, 15205, US

(21) Appl. No.: 09/725,375

(22) Filed: Nov. 29, 2000

(30) Foreign Application Priority Data
Dec. 3, 1999 (DE) 19958390.0

(51) Int. Cl. C08F 2/00; B01D 15/08; C02F 1/42; C02F 1/28; B01D 15/04; B01D 15/00; B01D 53/02

(52) U.S. Cl. 210/656; 521/31; 95/141; 210/660; 210/692; 210/688; 95/142; 95/143; 95/147

(57) ABSTRACT

The present invention relates to a process for preparing mono-disperse adsorber resin gels by polymerizing monomer droplets to give monodisperse polymers, followed by haloalkylating and crosslinking the resultant polymers, and also relates to the use of these resins.

### BACKGROUND OF THE INVENTION

The present invention relates to a process for preparing monodisperse adsorber resin gels by polymerizing monomer droplets to give monodisperse polymers, haloalkylating, and finally crosslinking the polymers, and also to the uses of the resins.

Polymer adsorbers are adsorbers with good adsorptive properties and performance characteristics. In numerous cases they are markedly superior to adsorbers based on carbon or inorganics. These polymer adsorbers are used to adsorb gaseous or liquid organic substances or dissolved organic substances. The adsorption of organic substances is particularly important here, and an especially important application is the treatment of wastewater.

The separating properties of the adsorber resins can also be used in chromatographic separation processes.

U.S. Pat. No. 5,416,124 or DD-A 249,703, for example, give a general description of the preparation of polymer adsorbers by reacting appropriate polymers with a haloalkylating reagent, e.g., monochlorodimethyl ether or α,α′-dichloroxylene. In another synthetic step the introduced halogenoalkyl groups are crosslinked with the polymer structure using a Friedel-Crafts catalyst in an inert swelling agent, with release of hydrogen halide. After removal of the swelling agent, the adsorber resins are washed.

DD-A 249,703, U.S. Pat. Nos. 5,460,725 and 5,416,124, respectively, obtain adsorbers in the manner described above by first chloromethylating the copolymer with monochlorodimethyl ether and then post-crosslinking the chloromethylated copolymer.

In the case of DD-A 249,703, use is made of copolymers with a divinylbenzene content of from 3 to 8% by weight. The chlorine content after the chloromethylation is intended to be from 11.5 to 17.8% by weight, corresponding approximately to a degree of substitution of 40 to 70%. The post-crosslinking of the dry, solvent-free (max. 5% of methanol) polymer containing chloromethyl groups takes place by reaction with a Friedel-Crafts catalyst, such as FeCl₃, SnCl₄, or AlCl₃, at temperatures above 75°C. in a swelling agent, such as dichloroethane or tetrachloroethane.

The macroporous polymers used in U.S. Pat. No. 5,416,124 are styrene-divinylbenzene copolymers, for example, prepared with addition of a porogen, such as C₆-C₈-hydrocarbons. Instead of styrene, use may also be made of ethylvinylbenzene or of a mixture made of both. The chloromethylation is intended to give a degree of substitution of from about 60 to 70%.

U.S. Pat. No. 5,416,124 also teaches that macroporous monodisperse adsorbers can be prepared and that they give particular advantages in chromatography.

According to U.S. Pat. No. 4,191,813, other synthesis strategies for preparing adsorbents of this type are based on downstream crosslinking of vinylbenzyl chloride copolymers by Friedel-Crafts catalysts in the presence of a swelling agent or on the post-crosslinking of polymers which comprise alkylating or acylating agents or comprise sulfur halides.

However, the last-named preparation processes have the disadvantage that some of the available starting materials used in the synthesis, for example vinylbenzyl chloride or polyfunctional alkylating agents, have to be removed again from the polymer when conversion is incomplete.

The disadvantage of the preparation described in U.S. Pat. Nos. 5,416,124 and 5,460,725 is that a porogen is needed for preparing the copolymer and has to be discharged from, and if desired reintroduced to, the preparation process.

The object of the present invention was to develop a very simple preparation process that provides the adsorbents described above with a large surface area, improved stability, improved adsorption properties, and also with low pressure loss when a liquid or gaseous medium is passed through the material. It would be advantageous here if the preparation of the adsorber resin could be incorporated into a preparation process for anion exchangers or if one of the conventional intermediates from the preparation of the anion exchangers could be further processed to give the adsorber.

### SUMMARY OF THE INVENTION

The present invention achieves the object by means of a process for preparing monodisperse, adsorber resin gels comprising

(a) reacting monomer droplets comprising at least one monovinylaromatic compound and at least one polyvinylaromatic compound and, if desired, an initiator or an initiator combination to give a monodisperse, crosslinked bead polymer,

(b) haloalkylated the monodisperse crosslinked bead polymer using haloalkylating agents such as monochlorodimethyl ether, and

(c) post-crosslinking the haloalkylated bead polymer in the presence of Friedel-Crafts catalysts.

### DETAILED DESCRIPTION OF THE INVENTION

In step (a), at least one monovinylaromatic compound and at least one polyvinylaromatic compound are used. However, it is also possible to use mixtures of two or more monovinylaromatic compounds and two or more polyvinylaromatic compounds.

Surprisingly, the monodisperse adsorber resin gels prepared according to the present invention give higher yield, high bead quality, high osmotic stability, and also a higher utilizable capacity during use than do the adsorbers known from the above-mentioned prior art. In addition, the adsorbers prepared according to the invention have good adsorption and desorption kinetics.

The monodisperse, crosslinked vinylaromatic base polymer of step (a) may be prepared by processes known from the literature. Examples of processes of this type are described in U.S. Pat. No. 4,444,961, EP-A 46,535, U.S. Pat. No. 4,419,245, WO-A 93/12167, the contents of which are incorporated into the present application by way of reference with regard to step (a). It is preferable for the monodisperse, crosslinked vinylaromatic base polymer to be prepared by the seed/feed method according to EP-A 46,535 or EP-A 51,210.

For the purposes of the present invention, an example of a copolymer that may be used in step (a) is a copolymer containing a monovinylaromatic compound and containing a polyvinylaromatic compound.

For the purposes of the present invention, preferred monovinylaromatic compounds in step (a) are monoethylenically unsaturated compounds such as styrene, vinyltoluene, ethylstyrene, α-methylstyrene, chlorostyrene, chloromethylstyrene, alkyl acrylates, or alkyl methacrylates.

For the purposes of the present invention, particularly preferred monoethylenically unsaturated compounds are styrene and mixtures made of styrene with the abovementioned monomers.

For the purposes of the present invention, preferred polyvinylaromatic compounds for step (a) are multifunctional ethylenically unsaturated compounds such as divinylbenzene, divinyltoluene, trivinylbenzene, divinylnaphthalene, trivinylnaphthalene, 1,7-octadiene, 1,5-hexadiene, ethylene glycol dimethacrylate, trimethylolpropane trimethacrylate, or allyl methacrylate.

The amounts of the polyvinylaromatic compounds used are generally from 1 to 20% by weight (particularly preferably from 2 to 8% by weight), based on the monomer or its mixture with other monomers. The nature of the polyvinylaromatic compounds (crosslinking agents) is selected with regard to the subsequent use of the bead polymer. Divinylbenzene is suitable in many cases. Commercial divinylbenzene grades that comprise ethylvinylbenzene besides the isomers of divinylbenzene are adequate for most applications.

In one preferred embodiment of the present invention, step (a) uses microencapsulated monomer droplets.

Possible materials for the microencapsulation of the monomer droplets are those known for use as complex coacervates, in particular polyesters, naturally occurring or synthetic polyamides, polyurethanes, or polyureas.

An example of a particularly suitable naturally occurring polyamide is gelatin, which is used in particular as coacervate or complex coacervate. For the purposes of the invention, gelatin-containing complex coacervates are especially combinations of gelatin with synthetic polyelectrolytes. Suitable synthetic polyelectrolytes are copolymers incorporating units of, for example, maleic acid, acrylic acid, methacrylic acid, acrylamide, or methacrylamide. Particular preference is given to the use of acrylic acid and acrylamide. Gelatin-containing capsules may be hardened with conventional hardening agents, such as formaldehyde or glutaric dialdehyde. The encapsulation of monomer droplets with gelatin, with gelatin-containing coacervates, or with gelatin-containing complex coaceravates is described in detail in EP-A 46,535. The methods for the encapsulation by synthetic polymers are known. An example of a highly suitable method is interfacial condensation, in which a reactive component dissolved in the monomer droplet, for example, an isocyanate or an acid chloride, is reacted with a second reactive component dissolved in the aqueous phase, for example, an amine.

The monomer droplets (which are optionally microencapsulated) may, if desired, comprise an initiator or mixtures of initiators to initiate the polymerization. Examples of initiators suitable for the novel process are peroxy compounds, such as dibenzoyl peroxide, dilauroyl peroxide, bis(p-chlorobenzoyl) peroxide, dicyclohexyl peroxydicarbonate, tert-butyl peroctoate, tert-butyl peroxy-2-ethylhexanoate, 2,5-bis(2-ethylhexanoylperoxy)-2,5-dimethylhexane, and tert-amylperoxy-2-ethylhexane, and also azo compounds, such as 2,2′-azobis(isobutyronitrile) and 2,2′-azobis(2-methylisobutyronitrile).

The amounts of the initiators used are generally from 0.05 to 2.5% by weight (preferably from 0.1 to 1.5% by weight), based on the monomer mixture.

The concepts “microporous” and “gel” and “macroporous” have been described in detail in the technical literature.

These bead polymers preferred for the purposes of the present invention and prepared in process step (a) have a gel structure and are prepared by processes as described in DE-A 19,852,667.

The conversion of the copolymers to the adsorber takes place in stage (b) by haloalkylation followed by post-crosslinking of the haloalkyl groups with aromatic rings in the polymer skeleton.

For the haloalkylation use is usually made of suitable reagents, preferably chloromethyl methyl ethers. These reagents, particularly chloromethyl methyl ether, may be used in unpurified form, in which case the chloromethyl methyl ether may contain methylal and methanol, for example, as ancillary components. An excess of the chloromethyl methyl ether is used and it acts not only as reactant but also as solvent and swelling agent. It is therefore generally not necessary to use another solvent. The chloromethylation reaction is catalyzed by adding a Lewis acid. Examples of suitable catalysts for the purposes of the invention are iron(III) chloride, zinc chloride, tin(IV) chloride, and aluminum chloride. The reaction temperature during the haloalkylation may be from 40 to 80°C. If the procedure is carried out at atmospheric pressure, a particularly advantageous temperature range is from 50 to 60°C. During the reaction, the volatile constituents, such as hydrochloric acid, methanol, methylal, formaldehyde, and some chloromethyl methyl ether, may be removed by evaporation. If chloromethyl methyl ether is used for the haloalkylation, the remainder of the chloromethyl methyl ether may be removed and the chloromethylate purified, by washing with methylal, methanol, and finally with water.

In step (c), the haloalkylated copolymer is converted to the adsorber by known processes, e.g., as described in DD-A 249,207.

The conversion may, if desired, be carried out directly in the haloalkylating agent, or the haloalkylated copolymer may be substantially freed from excess haloalkylating agents before being used in step (c).

For this, after step (b), haloalkylated polymer is, if desired, dried and swollen in a swelling agent, such as halogenated hydrocarbons or dichloroethane, and a Friedel-Crafts catalyst is added, for example, FeCl₃ (dry or in solution), H₂SO₄, or SnCl₄, and the reaction is carried out at an elevated temperature, preferably at the boiling point of the stirring medium, which may be identical to the swelling agent. According to the invention, the reaction can be carried out reliably at temperatures from 50 to 150°C.

The adsorbers prepared according to the invention are used for removing polar or non-polar, organic or inorganic compounds, such as color particles or heavy metals, from aqueous or organic solutions or gases, particularly those from the chemical industry, electrical industry, or food or drink industry. The adsorbers prepared according to the invention are preferably used

to remove polar compounds from aqueous or organic solutions,

to remove polar compounds from process streams from the chemical industry,

to remove color particles from aqueous or organic solutions,

to adsorb organic components from aqueous solutions, from air, or from gases, for example, to adsorb aldehydes, ketones, aromatic or aliphatic hydrocarbons, or aromatic or aliphatic chlorinated hydrocarbons, particularly formaldehyde acetone or chlorobenzene, or

to remove heavy metals, such as arsenic or selenium, from aqueous solutions.

The novel adsorbers may also be used for the purification or treatment of water in the chemical industry or electronics industry or in the food or drink industry, particularly for preparing ultrahigh-purity water, ultrahigh-purity chemicals or starch or hydrolysis products thereof.

The novel adsorbers may also be used for purifying aqueous solutions in the waste-disposal industry or waste-reclamation industry, for purifying wastewater streams from the chemical industry, or for waste incineration plants. Another application of the novel adsorbers is the purification of seepage water from landfill sites.

The novel adsorbers may also be used for treating drinking water or ground water.

The novel adsorbers may also be used for purifying air, for example, in closed spaces, or for purifying other gases.

The diameters of the monodisperse adsorbers are adapted to the task in hand and are determined firstly by the adsorption performance required and secondly by the pressure loss. For example, large beads have proven particularly successful in purifying gases and air.

The novel adsorption and desorption properties of the novel adsorbers are more sophisticated than those of organic components, and the adsorbers may be used successfully in chromatography systems for enrichment or separation of organic and/or inorganic components of various mixtures. In these systems small bead sizes are generally advantageous.

The following examples further illustrate details for the process of this invention. The invention, which is set forth in the foregoing disclosure, is not to be limited either in spirit or scope by these examples. Those skilled in the art will readily understand that known variations of the conditions of the following procedures can be used. Unless otherwise noted, all temperatures are degrees Celsius and all percentages are percentages by weight.

### EXAMPLES

### Example 1

a) Preparation of the polymer

a.1) Preparation of a seed polymer

1960 ml of deionized water were placed in a 4-liter glass reactor, and to this were added 630 g of a microencapsulated mixture made from 1.0% by weight of divinylbenzene, 0.6% by weight of ethylstyrene (used in the form of a commercially available mixture of divinylbenzene and ethyl styrene with 63% by weight of divinylbenzene), 0.5% by weight of tert-butyl 2-ethylperoxyhexanoate, and 97.9% by weight of styrene, the microcapsules being composed of a formaldehyde-hardened complex coacervate made from gelatin and from an acrylamide-acrylic acid copolymer. The average particle size was 231 μm. The mixture was mixed with a solution made from 2.4 g of gelatin, 4 g of sodium hydrogen phosphate dodecahydrate, and 100 mg of resorcinol in 80 ml of deionized water, slowly stirred, and polymerized at 75°C. for 10 h with stirring. The polymerization was then completed by increasing the temperature to 95°C. The mixture was washed using a 32 μm screen and dried to give 605 g of a bead-shaped microencapsulated polymer with a smooth surface. The polymers were visually transparent. The average particle size was 220 μm. The seed polymer had a volume swelling index of 4.7 and soluble fractions of 0.45%.

a.2) Preparation of a copolymer

416.9 g of seed polymer from (a) and an aqueous solution made from 1100 g of deionized water, 3.6 g of boric acid, and 1 g of sodium hydroxide were placed in a 4-liter glass reactor and the stirrer speed adjusted to 220 rpm. Within a period of 30 min, a mixture made from 713.4 g of styrene, 70 g of divinylbenzene (80.0% purity by weight), and 6.3 g of dibenzoylperoxide (75% purity by weight, moist with water) was added as feed. The mixture was stirred for 60 min at room temperature, with the gas space flushed with nitrogen. A solution of 2.4 g of methylhydroxyethylcellulose in 120 g of deionized water was then added. The mixture was then heated to 63°C. and held for 11 hours at this temperature, followed by heating at 95°C. for 2 hours. After cooling, the mixture was thoroughly washed with deionized water using a 40 μm screen and then dried in a drying cabinet at 80°C. for 18 hours to give 1150 g of a bead-shaped copolymer with a particle size of 370 μm.

b) Chloromethylation of the copolymer

A mixture made from 1600 g of monochlorodimethyl ether, 165 g of methylal, and 5 g of iron(III) chloride was placed in a 3-liter sulfonating beaker, after which then 300 g of copolymer from (a) were added. The mixture was allowed to stand for 30 min at room temperature and within a period of 3 h heated to reflux temperature (from 55 to 59°C.). This was followed by stirring for a further 1.75 h at reflux. During the reaction time about 275 g of hydrochloric acid and low-boiling organic compounds were driven off. The dark brown reaction suspension was then filtered off and the product obtained was thoroughly washed with a mixture of methylal and methanol, then with methanol, and with deionized water to give 680 g of chloromethylated bead polymer moistened with water. Chlorine content: 18.8%.

From the filtrate of this reaction mixture about 8 to 10 g of oligomers per 1000 g of polymer were precipitated with an excess of methanol.

100 ml of chloromethylated product moist from filtration weighed 65.9 g and contained 12.45 g of chlorine, corresponding to 0.351 mol.

c) Preparation of an adsorber

153 g (197 ml) of chloromethylated product were shaken into deionized water and the suspension transferred into a washing column. The supernatant water was allowed to run off. Using a laboratory steam generator, steam was then passed down onto the washing column at a rate of 600 ml of condensate per hour. The total take-off of condensate was about 2.5 to 3 bed volumes. The water-moistened chloromethylated product was transferred into a 4-necked flask equipped with thermometer, dropping funnel, and water separator and mixed with 460 ml of dichloroethane (“DCE”), and the reaction suspension was stirred for 30 min at room temperature. This was followed by heating at reflux for complete removal of water by the water separator. About 22 ml of water were removed from circulation. After the water had been removed from circulation, 44 g of a 40% strength FeCl₃ solution were fed in over a period of 2 h at reflux temperature. The water fed in by way of the solution was removed from circulation by the water separator. The mixture was then heated at reflux for about 15 h (bath temperature 120°C.). About 27 g of HCl were evolved. The mixture was cooled to room temperature and about 325 ml of DCE was separated off by way of a tubular sieve. The crude adsorber resin (355 ml) moist with DCE was transferred into a washing column. Steam was then passed down onto the washing column at a rate of 600 ml of condensate per hour using a laboratory steam generator. The total take-off of condensate was about 3 to 3.5 bed volumes. About 1000 ml of condensate were isolated, and 162 g (130 ml) of DCE and 885 g (890 ml) of aqueous phase could be separated off. After cooling to room temperature, the beads were first washed with 1175 ml of deionized water (about 5 bed volume), then with 180 ml of 2N NaOH (about 0.5 bed volume), and finally with 1175 ml of deionized water (about 5 bed volumes), and the product was separated off from the water using a suction funnel.

What is claimed is:

1. A process for preparing monodisperse, adsorber resin gels comprising
(a) reacting monomer droplets comprising at least one monovinylaromatic compound and at least one polyvinylaromatic compound and, if desired, an initiator or an initiator combination to give a monodisperse, crosslinked bead polymer,
(b) haloalkylated the monodisperse crosslinked bead polymer using haloalkylating agents such as monochlorodimethyl ether, and
(c) post-crosslinking the haloalkylated bead polymer in the presence of Friedel-Crafts catalysts.

2. A process according to claim 1 wherein step (a) is carried out using a seed-feed method.

3. A process according to claim 1 wherein the monovinylaromatic compound is selected from the group consisting of styrene, vinyltoluene, ethylstyrene, α-methylstyrene, chlorostyrene, chloromethylstyrene, alkyl acrylates, alkyl methacrylates, and mixtures thereof.

4. A process according to claim 1 wherein the polyvinylaromatic compound is selected from the group consisting of divinylbenzene, divinyltoluene, trivinylbenzene, divinylnaphthalene, trivinyinaphthalene, 1,7-octadiene, 1,5-hexadiene, ethylene glycol dimethacrylate, trimethylolpropane trimethacrylate, allyl methacrylate, and mixtures thereof.

5. A process according to claim 1 wherein the monomer droplets are microencapsulated.

6. A process according to claim 1 wherein any excess haloalkylating agent from step (b) is removed prior to the post-crosslinking.

7. A monodisperse, adsorber resin gel prepared by
(a) reacting monomer droplets comprising at least one monovinylaromatic compound and at least one polyvinylaromatic compound and, if desired, an initiator or an initiator combination to give a monodisperse, crosslinked bead polymer,
(b) haloalkylated the monodisperse crosslinked bead polymer using haloalkylating agents such as monochlorodimethyl ether, and
(c) post-crosslinking the haloalkylated bead polymer in the presence of Friedel-Crafts catalysts.

8. A method for removing polar or non-polar, organic or inorganic compounds or heavy metals from aqueous or organic solutions or gases comprising exposing the aqueous or organic solutions or gases to a monodisperse adsorber resin gel according to claim 7.

9. A method according to claim 8 wherein the aqueous or organic solutions or gases are generated in the chemical industry, electrical industry, food or drink industry, waste-disposal industry, or waste-reclamation industry.

10. A method according to claim 8 wherein aldehydes, ketones, aromatic or aliphatic hydrocarbons, or aromatic or aliphatic chlorohydrocarbons are adsorbed from air or other gases.

11. A method for treating drinking water or ground water comprising exposing drinking water or ground water to a monodisperse adsorber resin gel according to claim 7.

12. A chromatographic separation method of separating organic and/or inorganic components of mixtures comprising exposing such mixtures to a monodisperse adsorber resin gel according to claim 7.
